(19) United States
(12) Patent Application Publication
(10) Pub. No.: US 2007/0154778 A1
(43) Pub. Date: Jul. 5, 2007

(54) Gas diffusion electrodes, method for the production of gas diffusion electrodes, and fuel cells using said gas diffusion electrodes

(75) Inventors: Stefan Haufe, Goettingen (DE); Annette Reiche, Goettingen (DE); Suzana Kiel, Goettingen (DE); Ulrich Maehr, Berlin (DE); Dieter Melzner, Goettingen (DE)

Correspondence Address: SUGHRUE MION, PLLC, 2100 PENNSYLVANIA AVENUE, N.W., SUITE 800, WASHINGTON, DC, 20037, US

(73) Assignee: SARTORIUS AG

(21) Appl. No.: 11/650,460

(22) Filed: Jan. 8, 2007

Related U.S. Application Data
(63) Continuation of application No. PCT/EP05/07163, filed on Jul. 2, 2005.

(30) Foreign Application Priority Data
Jul. 8, 2004 (DE) 10 2004 032 999.0

(51) Int. Cl. H01M 4/94; H01M 4/92; H01M 4/88

(52) U.S. Cl. 429/42; 429/44; 502/101

(57) ABSTRACT

Gas diffusion electrodes with improved proton conduction between an electrocatalyst located in a catalyst layer and an adjacent polymer electrolyte membrane, capable of being used at operating temperatures up to or above the boiling point of water, ensuring lasting high gas permeability. Also, a production method and corresponding fuel cells. At least one part of the particles of an electrically conductive carrier material in the catalyst layer is at least partially loaded with at least one porous, proton-conducting polymer which can be used up to or above the boiling point of water. Loading and development of the porous structure is carried out in a phase inversion method. The gas diffusion electrodes can be used in high temperature fuel cells working at temperatures up to or above the boiling temperature of water without a drop in performance in continuous operation.

This is a Continuation of International Application PCT/EP2005/007163, with an international filing date of Jul. 2, 2005, which was published under PCT Article 21(2) in German, and the disclosure of which is incorporated into this application by reference;

the International Application PCT/EP2005/007163, in turn, claims priority to German Application No. 10 2004 032 999.0 filed on Jul. 8, 2004.

### FIELD AND BACKGROUND OF THE INVENTION

The invention relates to gas diffusion electrodes with a plurality of gas permeable electrically conductive layers, a method for producing gas diffusion electrodes, and fuel cells for operating temperatures of up to at least 200° C. having membrane electrode units using such gas diffusion electrodes.

U.S. Pat. No. 4,876,115 discloses a gas diffusion electrode for membrane electrode units with polymer electrolyte membranes used in fuel cells and a method for their production. This gas diffusion electrode is formed of a gas diffusion layer and a gas permeable catalyst layer that is in contact with a solid polymer electrolyte membrane. The gas permeable catalyst layer is formed of particles of an electrically conductive carrier material, on the surface of which a catalyst material is dispersed. The interstitial spaces formed by the particles permit the reaction gases to penetrate through the electrode structure to the adjacent catalysts, where the electrochemical reactions take place. To control the wetting properties of the electrodes, maintain gas permeability and increase strength, additional particles are present, such as PTFE particles, for example.

In addition, a proton-conducting material is sprayed, deposited or brushed onto the catalyst layer to enhance conduction of the protons between the catalyst particles and the polymer electrolyte membrane. Nafion® and ruthenium dioxide are proposed as the proton-conducting material. A disadvantage is that Nafion® has low porosity and gas permeability, so that if too much Nafion® is applied, the gas permeability of the catalyst layer is blocked or at least substantially reduced. Nafion® must therefore be sprayed on in several layers, which is costly. Furthermore, the catalyst particles that are not located on the surface of the catalyst layer are not, or not sufficiently, contacted by the Nafion®. Consequently proton conduction cannot be improved in these areas. A further disadvantage is that Nafion® is not suitable either as a membrane or a proton-conducting electrode component of the gas diffusion electrode in high-temperature polymer electrolyte membrane fuel cells, which work at operating temperatures of up to at least 200° C., because Nafion® is unstable at temperatures higher than 100° C. in continuous operation. With respect to the gas diffusion electrode this means, on the one hand, impairment of the gas permeability because the electrode structure tends to sinter together. On the other hand, the splitting off of sulfonic acid groups at temperatures >100° C. results in a loss of proton-conducting properties.

The expansion of the working temperature range of polymer electrolyte membrane fuel cells to temperatures of up to at least 200° C. is desirable for several reasons because of the advantages connected therewith. On the one hand, it enhances the electrode kinetics, and the catalyst of the anode becomes substantially less sensitive to carbon monoxide and other catalyst poisons. Thus, the cost of gas purification with the use of hydrogen from reformed gas can be substantially reduced. Furthermore, the waste heat of the cell can be used more effectively because of the higher temperature level.

According to WO 01/18894 A2, gas diffusion electrodes are produced by applying a paste or a suspension of a catalyst powder in a solution of polybenzimidazole (PBI) in dimethylacetamide (DMAc) to a gas diffusion layer, and a solid layer is produced by eliminating the solvent. The electrode layer is impregnated with phosphoric acid to obtain proton conductivity by doping the polymer with acid. At the same time, the acid is immobilized. A disadvantage is that the PBI layers produced from a solution of the polymer in dimethylacetamide by eliminating the solvent are thick films. Because the polymer is uniformly distributed within the entire active electrode layer due to the described production process, the gas permeability of the electrode is substantially lowered, and the accessibility to the catalyst of the reaction gases is reduced. At the same time, the removal of product water is impeded. As a result, the phosphoric acid doped PBI comes into intensive contact with the product water, which can lead to a discharge of phosphoric acid and results in a decrease in the proton conductivity in the electrode.

### SUMMARY OF THE INVENTION

One object of the invention is therefore to provide gas diffusion electrodes for fuel cells with improved proton conduction, independent of the operating conditions, between an electrocatalyst present in a catalyst layer and an adjacent polymer electrolyte membrane, which can be used at operating temperatures up to or above the boiling point of water, and which ensure permanent high gas permeability of the catalyst layer. Other objects of the invention are to provide methods for efficiently producing gas diffusion electrodes of this type and fuel cells with operating temperatures up to or above the boiling point of water using these gas diffusion electrodes.

An object of the invention is attained by gas diffusion electrodes having a plurality of gas permeable electrically conductive layers, which are formed of at least one gas diffusion layer and one catalyst layer. The catalyst layer has at least particles of an electrically conductive carrier material. At least one part of the particles carries an electrocatalyst, which preferably resides on the surface of the particles. At least one part of the particles is at least partially loaded with at least one porous proton-conducting polymer. This porous proton-conducting polymer may be used at temperatures up to or above the boiling point of water and/or is stable up to at least 200° C. Loading the surface of the particles of the electrically conductive carrier material with a proton-conducting polymer having a porous structure has the significant advantage that it realizes excellent proton conduction between the electrocatalyst located in the catalyst layer and an adjacent polymer electrolyte membrane. Corresponding concentrations of the loaded particles make it highly probable that the proton-conducting polymer layer of a particle in the catalyst layer is in direct contact with the proton-conducting polymer layer of an adjacent particle in the catalyst layer or the polymer electrolyte membrane in a membrane electrode unit (MEU) of a fuel cell. The porosity of the proton-conducting polymer layer, which is stable up to at least 200° C., ensures not only high gas permeability of the catalyst layer, but also unimpeded transport of the gaseous fuels and oxidants as well as the gaseous reaction products to the electrode catalysts and from there onward. The porosity of the proton-conducting polymer layer is adjustable at least in the range of pore diameters of approximately 0.001 to 0.1 μm. The loading percentage of the particle surface and the loading thickness are likewise adjustable. The thickness of the particle coating is preferably 0.1 to 10 percent of the particle diameter, and 50 to 100 percent of the surface of the particles is preferably loaded. Selecting proton-conducting polymers that can be used at temperatures up to or above the boiling point of water and/or are mechanically and thermally stable up to at least 200° C. makes it possible to use the gas diffusion electrodes according to the invention in high-temperature fuel cells, which operate at temperatures up to or above the boiling point of water and/or at least 200° C. without a loss of performance in continuous operation. This is partly due to the fact that the porous structure of the selected proton-conducting polymers does not collapse at these temperatures, and the structure of the gas diffusion electrodes is thus preserved.

Another object of the invention is attained by a method for producing gas diffusion electrodes having a plurality of gas permeable, electrically conductive layers formed of at least one gas diffusion layer and one catalyst layer. The catalyst layer has at least particles of an electrically conductive carrier material and at least one part of the particles carries an electrocatalyst and/or is loaded with at least one porous proton-conducting polymer, and this polymer is stable at temperatures up to or above the boiling point of water and/or up to at least 200° C. In the method according to the invention, the following steps are performed:
A) The surface of the at least one part of the particles of the electrically conductive carrier material is at least partially loaded with the at least one proton-conducting polymer. To this end, the particles are suspended in a liquid in which the at least one proton-conducting polymer is dissolved. The suspension is successively added to an agitated non-solvent for the polymer to initiate a phase inversion, thereby forming a porous polymer structure on the surface of the particles of the carrier material and porous particles of the at least one proton-conducting polymer;
B) Providing at least the electrically conductive particulate carrier material for the catalyst layer in which at least one part of the particles carries an electrocatalyst and/or is at least partially loaded with at least the porous proton-conducting polymers obtained in step A);
C) Forming the catalyst layer into an electrode form; and
D) Contacting the formed catalyst layer with one of the sides of the gas diffusion layer.

Another object of the invention is attained by fuel cells formed of at least one membrane electrode unit (MEU), which is.formed of two planar gas diffusion electrodes according to the invention, a membrane disposed therebetween in a sandwich construction, and a dopant for the membrane. The gas diffusion electrodes according to the invention have a plurality of gas permeable electrically conductive layers that are formed of at least one gas diffusion layer and one catalyst layer. The catalyst layer has at least particles of an electrically conductive carrier material, and at least one part of the particles carries an electrocatalyst and/or is at least partially loaded with at least one porous proton-conducting polymer, and this polymer can be used at temperatures up to or above the boiling point of water and/or is stable up to at least 200° C.

### BRIEF DESCRIPTION OF THE DRAWINGS

In the accompanying drawings:

FIG. 1 shows the current density-voltage curve for one embodiment of a fuel cell according to the invention; and

FIG. 2 shows the current density-voltage curve for another embodiment of a fuel cell according to the invention.

### DETAILED DESCRIPTION OF THE PREFERRED EMBODIMENTS

The gas diffusion electrodes have a plurality of gas permeable electrically conductive layers, which are formed of at least one gas diffusion layer and one catalyst layer. The catalyst layer has at least particles of an electrically conductive carrier material. At least one part of the particles carries an electrocatalyst, which preferably resides on the surface of the particles. At least one part of the particles is at least partially loaded with at least one porous proton-conducting polymer. This porous proton-conducting polymer may be used at temperatures up to or above the boiling point of water and/or is stable up to at least 200° C. Loading the surface of the particles of the electrically conductive carrier material with a proton-conducting polymer having a porous structure has the significant advantage that it realizes excellent proton conduction between the electrocatalyst located in the catalyst layer and an adjacent polymer electrolyte membrane. Corresponding concentrations of the loaded particles make it highly probable that the proton-conducting polymer layer of a particle in the catalyst layer is in direct contact with the proton-conducting polymer layer of an adjacent particle in the catalyst layer or the polymer electrolyte membrane in a membrane electrode unit (MEU) of a fuel cell. The porosity of the proton-conducting polymer layer, which is stable up to at least 200° C., ensures not only high gas permeability of the catalyst layer, but also unimpeded transport of the gaseous fuels and oxidants as well as the gaseous reaction products to the electrode catalysts and from there onward. The porosity of the proton-conducting polymer layer is adjustable at least in the range of pore diameters of approximately 0.001 to 0.1 μm. The loading percentage of the particle surface and the loading thickness are likewise adjustable. The thickness of the particle coating is preferably 0.1 to 10 percent of the particle diameter, and 50 to 100 percent of the surface of the particles is preferably loaded. Selecting proton-conducting polymers that can be used at temperatures up to or above the boiling point of water and/or are mechanically and thermally stable up to at least 200° C. makes it possible to use the gas diffusion electrodes according to the invention in high-temperature fuel cells, which operate at temperatures up to or above the boiling point of water and/or at least 200° C. without a loss of performance in continuous operation. This is partly due to the fact that the porous structure of the selected proton-conducting polymers does not collapse at these temperatures, and the structure of the gas diffusion electrodes is thus preserved.

Proton-conducting polymers should be understood to mean polymers that are proton-conducting per se or are made proton-conducting, e.g., through absorption of a dopant, such as a strong inorganic acid.

In a preferred embodiment of the invention, the catalyst layer furthermore has porous particles that are formed of at least the porous proton-conducting polymers. By a corresponding selection of the parameters and reaction control of the phase inversion process for loading the particles of the electrically conductive carrier material with the porous proton-conducting polymers, it is possible to produce such porous particles together with the former. They may also be produced separately, however. In another advantageous embodiment of the invention, an additional gas distributing microstructure layer of electrically conductive particles is located between the catalyst layer and the gas diffusion layer. These electrically conductive particles are preferably formed of carbon black. This enhances electron conduction and achieves uniform gas distribution in the gas diffusion electrodes. As a rule, the gas diffusion layer of the gas diffusion electrodes is formed of carbon, particularly in the form of carbon fibers processed into paper, nonwovens, lattices, knit fabrics or woven fabrics.

The electrically conductive carrier material of the catalyst layer is selected from the group consisting of metals, metal oxides, metal carbides, carbons and mixtures thereof. Carbon black in particle form is preferably selected from the carbons.

Particularly suitable are carbon blacks such as Vulcan XC or Shawinigan Black, as well as graphitized spherical carbon blacks or mesocarbon microbeads.

The electrocatalysts used are metals and metal alloys or mixtures thereof. Metals selected from the 8th subgroup of the periodic system have proven especially successful.

Among these, platinum, iridium and/or ruthenium are preferred. Platinum is particularly preferred. Loading is preferably 5 to 40 weight percent of the electrocatalyst on the carrier. The catalyst particle size may be approximately 2 to 10 nm.

In a preferred embodiment of the invention, the at least one porous proton-conducting polymer is formed of a polymer which contains at least one nitrogen atom and the nitrogen atom(s) of which are chemically bonded to central atoms of polybasic inorganic oxo acids or their derivatives. Polybasic inorganic oxo acids are defined as acids having the general formula HₙXOₘ, where n>1, m>2 and n>m and X is an inorganic central atom (n and m are integers) (Cotton/Wilkinson, Inorganic Chemistry, Verlag Chemie, Weinheim, Deerfield Beach, Fla., Basel 1982, 4th ed., pp. 238-239).

Examples of the central atom are phosphorus, sulfur, molybdenum, tungsten, arsenic, antimony, bismuth, selenium, germanium, tin, lead, boron, chromium and silicon.

Preferred are phosphorus, molybdenum, tungsten and silicon; phosphorus is particularly preferred.

Preferred derivatives of the oxo acids are organic derivatives in the form of alkoxy compounds, esters, amides and acid chlorides. In one embodiment of the invention, organic derivatives of the oxo acids di-(2-(ethylhexyl) phosphoric acid ester, molybdenyl acetyl acetonate and tetraethoxysilane are particularly preferred.

The nitrogen atom-containing polymer is selected from the group consisting of polybenzimidazoles, polypyrridines, polypyrimidines, polyimidazoles, polybenzothiazoles, polybenzoxazoles, polyoxadiazoles, polyquinoxalines, polythiadiazoles, poly(tetrazapyrenes), or the polymer carries reactive groups in the side chain capable of forming amide bonds, or has primary and secondary amino groups as well as a combination of two or more thereof or with other polymers.

The nitrogen atom-containing polymer may be mechanically and thermally stable and have a glass transition temperature greater than 200° C.

The aforementioned proton-conducting polymers, which contain covalently bonded units of oxo acids do not, per se, have sufficient proton-conducting properties adequate for use in gas diffusion electrodes. Surprisingly it has been found, however, that these polymers have an excellent capability of absorbing and fixing dopants, such as phosphoric acid. The dopant remains strongly fixed in the polymers used according to the invention not only at temperatures of up to at least 200° C., but also at temperatures below 100° C., so that it is not discharged from the gas diffusion electrodes even in the startup and stopping range of fuel cells. In addition, the proton-conducting polymers have greater hydrophobicity compared to conventional polybenzimidazoles, which means that they do not absorb the product water of the fuel cell, so that the discharge of phosphoric acid is prevented or at least substantially reduced.

It is advantageous that the affinity for water of the at least one proton-conducting polymer can be adjusted by the type and number of hydrophilic and hydrophobic groups introduced into the polymer and/or the oxo acid derivatives. The person skilled in the art will be familiar with this type of reaction.

It has been found to be advantageous if the at least one proton-conducting polymer and the central atom of the oxo acid or the oxo acid derivative are cross-linked into a network. The cross-linked polymer coating has increased mechanical stability and stabilizes the particles coated therewith and the structure formed of these particles. The cross-linked polymer coating is furthermore particularly effective to absorb dopants, such as phosphoric acid, for example, developing excellent proton-conducting properties. The network is at least two-dimensional, preferably, however, three-dimensional, particularly with a low proportion of oxo acid units relative to the polymer. Proton-conducting polymers particularly suitable for use in gas diffusion electrodes have a degree of cross-linking of at least 70 percent of the polymer, preferably more than 80 percent, particularly preferably more than 90 percent.

It can be advantageous if the particles of the electrically conductive carrier material are loaded with different porous proton-conducting polymers. In a special embodiment of the invention, the part of, the particles of the electrically conductive carrier material which carries an electrocatalyst is loaded with a different porous proton-conducting polymer than the part of the particles without electrocatalyst. Because of the covalently bonded oxo acid derivative, the coating of the carrier material containing the catalyst is itself catalytically active or supports the electrocatalyst in its function.

Gas diffusion electrodes according to the invention can moreover contain additives in the catalyst layer. Such additives include binders, such as perfluoropolymers, or particles of structure enhancing additives, such as spherical carbon based particles.

A method for producing gas diffusion electrodes having a plurality of gas permeable, electrically conductive layers formed of at least one gas diffusion layer and one catalyst layer will now be described in further detail. The catalyst layer has at least particles of an electrically conductive carrier material and at least one part of the particles carries an electrocatalyst and/or is loaded with at least one porous proton-conducting polymer, and this polymer is stable at temperatures up to or above the boiling point of water and/or up to at least 200° C. In the method according to the invention, the following steps are performed:
A) The surface of the at least one part of the particles of the electrically conductive carrier material is at least partially loaded with the at least one proton-conducting polymer. To this end, the particles are suspended in a liquid in which the at least one proton-conducting polymer is dissolved. The suspension is successively added to an agitated non-solvent for the polymer to initiate a phase inversion, thereby forming a porous polymer structure on the surface of the particles of the carrier material and porous particles of the at least one proton-conducting polymer;
B) Providing at least the electrically conductive particulate carrier material for the catalyst layer in which at least one part of the particles carries an electrocatalyst and/or is at least partially loaded with at least the porous proton-conducting polymers obtained in step A);
C) Forming the catalyst layer into an electrode form; and
D) Contacting the formed catalyst layer with one of the sides of the gas diffusion layer.

Suitable liquids are those in which the polymers dissolve. Preferred are N-methylpyrrolidone (NMP), dimethylformamide (DMF), dimethylsulfoxide (DMSO), dimethylacetamide (DMAc) and mixtures thereof DMAc is preferred.

The concentration of the at least one polymer in the suspension ranges between 0.05 and 5 weight percent, particularly preferably between 0.1 and 1 weight percent. The proportion of the particles of the electrically conductive carrier material in the suspension is adjusted to a range of 5 to 30 weight percent, particularly preferably a range of 10 to 15 weight percent. Thus, there is approximately 0.1 to 10 weight percent of polymer relative to the amount of electrically conductive carrier material in the suspension, particularly preferably 0.5 to 2 weight percent. The ratio of carrier material to polymer depends on the desired thickness of the polymer layer to be produced on the carrier material particles. In a preferred embodiment, the suspension furthermore contains the neutralized derivative of an oxo acid at a concentration ranging between 0.01 and 0.5 weight percent, particularly preferably 0.1 to 0.3 weight percent. Thus, there is approximately 10 to 400 weight percent, particularly preferably 200 to 350 weight percent of oxo acid derivative relative to the amount of polymer in the suspension. The ratio between polymer and oxo acid derivative depends on the reactivity of the polymer and the oxo acid derivative. In another embodiment, the suspension contains additional cross-linker molecules or a catalyst. The concentration of the additional cross-linker molecules is between approximately 1 to 10 weight percent relative to the polymer, particularly preferably 2 to 5 weight percent. The concentration of the catalyst ranges from 0.1 to 5 weight percent relative to the polymer, particularly preferably from 0.5 to 2 weight percent. In yet another embodiment, the suspension contains pore-forming additives.

The suspension is produced by successively adding the electrically conductive carrier material and the formulation ingredients, which are partly dissolved in the solvent, to the polymer solution and stirring for approximately 30 minutes, preferably at room temperature.

The non-solvent is preferably water. The non-solvent may also contain additives influencing particle formation and pore formation during the phase inversion process. As the suspension is fed into the non-solvent, the non-solvent is intensively stirred to obtain good distribution of the suspension components and to prevent the particles from sticking together. The suspension is added to the non-solvent at room temperature. The product of suspension and non-solvent is preferably stirred for approximately one hour at temperatures ranging from 50 to 100° C., preferably 80 to 95° C. To produce a powder, the method according to the invention is followed by a drying step. Drying is done using a conventional powder drying process, which will be familiar to the person skilled in the art. In the simplest case, drying is effected in the drying chamber over a period of approximately 24 hours at temperatures ranging from 50 to 200° C., particularly preferably at temperatures ranging from 80 to 150° C. However, powder drying may also be done by freeze-drying to obtain a particular fine-grained powder.

The diameter of the pores in the proton-conducting polymer layer can be adjusted to a range of approximately 1 nm to 1 μm, where specific parameters of the phase inversion process by which the layers are produced, such as concentration of the polymer in the suspension, type of the oxo acid derivative, addition of pore forming agents and composition of the precipitation bath, are modified. The loading percentage of the particle surface and the loading density can be adjusted particularly by means of the concentration of the proton-conducting polymer in the suspension from which the porous polymer layer is produced in the phase inversion process. The layer thickness of the polymer with which the particles are loaded is less than 1 μm. Surprisingly, it has been found that when the method according to the invention is used, the particles loaded with the at least one proton-conducting polymer do not stick together but are preserved as separate particles, which is also evident in SEM photographs.

By providing proton-conducting polymer-coated and uncoated particles of the electrically conductive carrier material, the electrocatalyst can be distributed in the catalyst layer of the gas diffusion electrode in such a way that the electrocatalyst is bonded to the polyelectrolyte membrane in a proton-conducting manner, but is not coated with the proton-conducting polymer so completely that its function is affected.

In a preferred embodiment of the method according to the invention, additives are added to the provided carrier material before step C) is performed. Possible additives are binders, such as perfluoropolymers, and structure-forming additives, such as additional spherical carbon particles, or pore forming agents.

If the electrically conductive particulate carrier material is used for the catalyst layer in powder form, the forming of the catalyst layer into the electrode form is preferably done by rolling the powder. Compared to using uncoated electrically conductive carrier material, the use of the polymer-coated carrier material according to the invention has the advantage of substantially improving the mechanical stability of the formed electrode strip. If the electrically conductive particulate carrier material is used for the catalyst layer in the form of a suspension or paste, the catalyst layer is formed into the electrode form preferably by applying the suspension or paste to at least one substrate and subsequent drying. Again, the use of the polymer-coated carrier material according to the invention has the advantage of substantially improving suspensibility compared to uncoated carrier material.

The two basic embodiments for forming the catalyst layer can use either the gas diffusion layer or the membrane as a substrate. In the first case, the catalyst layer is contacted with the gas diffusion layer during formation of the catalyst layer. In the second case, the catalyst layer on the membrane is contacted with the gas diffusion layer according to (D).

In a special embodiment, the formed catalyst layer can be tempered again before further processing, either alone or catalyst layer and gas diffusion layer combined, in order to stabilize the composite or cure the pore-forming agent. It has proven useful to apply an additional gas-diffusing microstructure layer of electrically conductive particles to the side of the gas diffusion layer contacted with the catalyst layer.

In a preferred embodiment of the method according to the invention, the proton-conducting polymers used in step (A) are polymers containing at least one nitrogen atom whose nitrogen atom(s) are chemically bonded to the central atoms of polybasic inorganic oxo acids or their derivatives. In a preferred embodiment, the reaction between the polymer and the oxo acid or its derivative takes place during the process of step (A).

The nitrogen atom-containing polymers used are preferably polymers selected from the group consisting of polybenzimidazole (PBI), polypyrridine, polypyrimidine, polyimidazoles, polybenzothiazo les, polybenzoxazo les, po lyoxadiazo les, polyquinoxalines, polythiadiazoles, poly(tetrazapyrenes), and polymers carrying reactive groups capable of forming amide bonds in the side chain or having primary and secondary amino groups, as well as a combination of two or more thereof or with other polymers. In a further preferred embodiment of the invention, oxo acids or their derivatives whose central atom is phosphorus, sulfur, molybdenum, tungsten, arsenic, antimony, bismuth, selenium, germanium, tin, lead, boron, chromium and/or silicon are used. The derivatives of the oxo acids are preferably organic derivatives in the form of alkoxy compounds, esters, amides and acid chlorides. Particularly preferred are 2-(diethylhexyl) phosphoric acid ester, molybdenyl acetyl acetonate and tetraethoxysilane. The proportion of organic derivatives of the oxo acids is adjusted within a range of 10 to 400 weight percent, particularly preferably 200 to 350 weight percent, relative to the content of the nitrogen-atom-containing polymer.

In one embodiment of the method according to the invention, the particles of the carrier material are loaded with a polymer of PBI and 2-(diethylhexyl) phosphoric acid ester. A PBI is selected which, in the form of a solution of 1 weight percent in DMAc, has an intrinsic viscosity or limit viscosity of 0.90 dl/g or higher at 25° C. The average molar mass obtained from the intrinsic viscosity using the Mark-Houwink equation is 60,000 g/mol and higher. According to the invention, a PBI with a molar mass ranging from 35,000 to 100,000 g/mol is generally used.

Particularly stable gas diffusion electrodes are obtained if the at least one proton-conducting polymer and the oxo acid derivative are cross-linked into a network by the effect of heat. In a preferred embodiment, after the phase inversion process and subsequent powder drying, the polymer coated electrically conductive carrier material is hardened for approximately 1 hour at temperatures ranging from 100 to 300° C., preferably 150 to 250° C., to complete the cross-linking of the polymer with the oxo acid derivative. Depending on the polymer and oxo acid derivative used, and depending on the tempering temperature, it may be necessary to extend the tempering process to up to approximately 5 hours. The mechanical stability of the polymer coating on the particles of the electrically conductive carrier material can be influenced by the type and concentration of the oxo acid derivative used.

Advantageously, the affinity for water of the at least one proton-conducting polymer is adjusted by means of the type and number of hydrophilic and hydrophobic groups on the polymer and/or the oxo acid derivatives.

Fuel cells formed of at least one membrane electrode unit (MEU), which is formed of two planar gas diffusion electrodes according to the invention, a membrane disposed therebetween in a sandwich construction, and a dopant for the membrane, will now be described in further detail. The gas diffusion electrodes according to the invention have a plurality of gas permeable electrically conductive layers that are formed of at least one gas diffusion layer and one catalyst layer. The catalyst layer has at least particles of an electrically conductive carrier material, and at least one part of the particles carries an electrocatalyst and/or is at least partially loaded with at least one porous proton-conducting polymer, and this polymer can be used at temperatures up to or above the boiling point of water and/or is stable up to at least 200° C.

The gas diffusion electrodes are loaded with the dopant such that they constitute a dopant reservoir for the membrane. The membrane becomes proton-conducting through absorption of the dopant and is bonded to the gas diffusion electrodes in a proton-conducting manner under the influence of pressure and temperature. As an alternative, the membranes can be impregnated directly with the dopant before the MEU is assembled. Phosphoric acid is preferred as the dopant material. The fuel cell can be used for hydrogen/air operation at operating temperatures between room temperature and up to or above the boiling point of water and/or up to at least 200° C. In a preferred embodiment of the fuel cells according to the invention, the gas diffusion electrodes and the polymer electrolyte membrane of the MEU have the same at least one proton-conducting polymer.

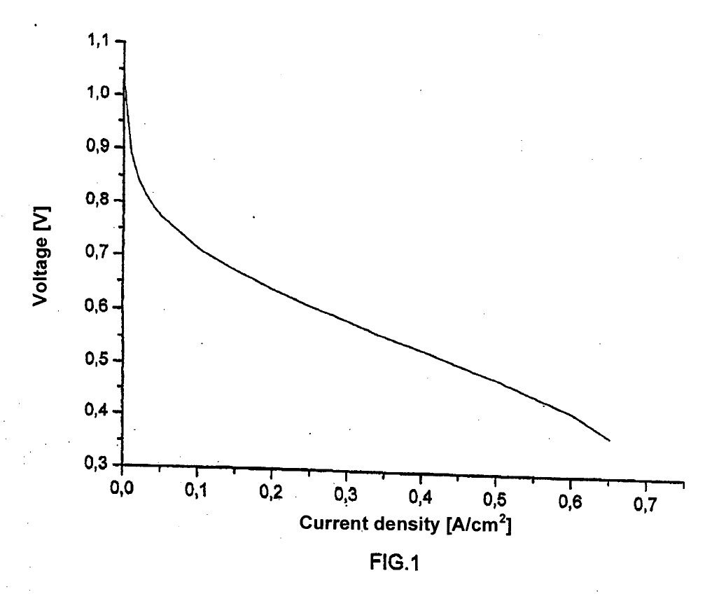

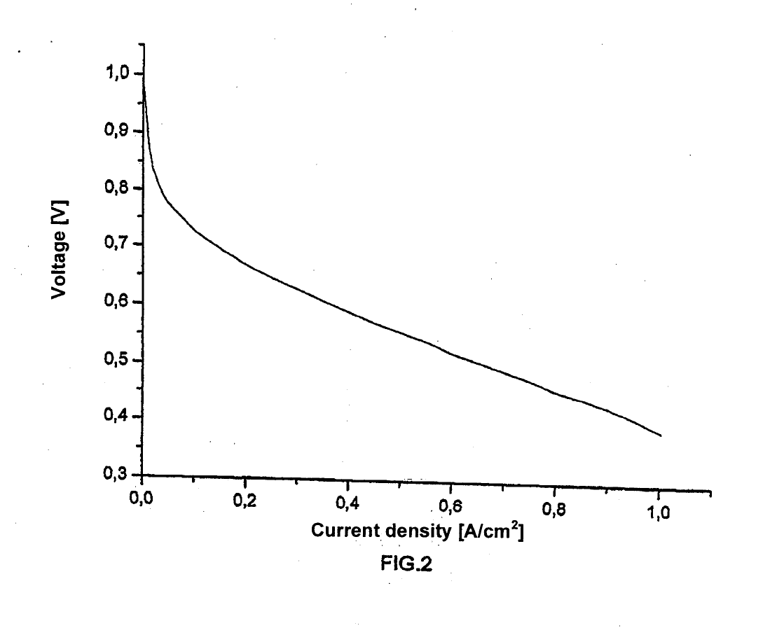

The invention will now be described in greater detail with reference to FIGS. 1 and 2 and Examples 1 to 8.

### EXAMPLE 1

### Producing Particles of an Electrically Conductive Carrier Material Loaded with at Least One Porous Proton-Conducting Polymer for the Catalyst Layer

To 102.1 ml of a 0.5 weight percent solution of PBI in DMAc are added successively while stirring: 10 g of a 0.2 weight percent solution of 1,4-butanedioldiglycidyl ether in DMAc and 10.1 g of a 1 weight percent solution of di-(2-ethylhexyl) phosphoric acid ester in DMAc. 250 g of a 50 weight percent suspension (slurry) of catalyst carbon black in DMAc is added to this solution while stirring. The catalyst carbon black consists of Shawinigan Black sold by Cabot SMP, loaded with 20 percent platinum. This suspension is stirred for approximately 30 min. at room temperature and then dripped into 3 liters of distilled water with vigorous stirring. After completion of the phase inversion process, the suspension (slurry) thus obtained is heated to 100° C. over approximately 1 hour, subsequently cooled to approximately 50° C. while stirring and then filtered. The filtrate is dried at 100° C. overnight in the drying chamber and subsequently passed through a screen with a 50-μm mesh size. The particles, which are now coated with a porous PBI, are tempered at 200° C. in an inert gas atmosphere in the drying chamber for one hour.

### EXAMPLE 2

### Producing Particles of an Electrically Conductive Carrier Material Loaded with at Least One Porous Proton-Conducting Polymer for the Catalyst Layer

To 102.1 ml of a 0.5 weight percent solution of PBI in DMAc are added while stirring: 10 g of a 0.2 weight percent solution of 1,4-butanedioldiglycidyl ether in DMAc and 10.1 g of a 1 weight percent solution of di-(2-ethylhexyl) phosphoric acid ester in DMAc. 250 g of a 50 weight percent suspension (slurry) of Vulcan XC 72 sold by More Energy (carbon black) in DMAc is added to this solution while stirring. This suspension is stirred at room temperature for approximately 30 minutes and subsequently dripped into 3 liters of distilled water while stirring vigorously. After completion of the phase inversion process, the obtained suspension (slurry) is heated to 100° C. over approximately 1 hour, again stirring, then cooled to approximately 50° C. while stirring and subsequently filtered. The filtrate is dried overnight at 100° C. in the drying chamber and subsequently passed through a screen with a 50-μm mesh size. The carbon black, which is now coated with a porous PBI, is tempered at 200° C. for an hour in the drying chamber in an inert gas atmosphere.

### EXAMPLE 3

### Producing Gas Diffusion Electrodes with an Electrically Conductive Carrier Material Obtained According to Example 1 Using a Suspension Method

4.3 g of the polymer coated carrier material produced according to Example 1 are suspended in 62.6 g DMAc for 20 minutes using an UltraTurrax type (IKA) homogenizer. 1.6 g of a 62 weight percent suspension of PTFE particles (Dyneon TF 5235 PTFE) in DMAc are added to this suspension and blended using the UltraTurrax (IKA), again for 20 minutes. The finished suspension is sprayed onto a 250 μm thick FC X0026 type gas diffusion layer sold by Freudenberg using an airbrush. The gas diffusion layer coated with the catalyst layer is dried for 30 minutes at 120° C. in an N₂ stream.

The finished gas diffusion electrode has a total thickness of 420 μm and a platinum content of 2.8 mg/cm².

### EXAMPLE 4

### Producing Gas Diffusion Electrodes with an Electrically Conductive Carrier Material Obtained According to Example 2 Using a Suspension Method

2.5 g of the polymer-coated carbon black carrier material produced according to Example 2 and 5 g of an electrically conductive carrier material consisting of Shawinigan Black sold by Cabot SMP, loaded with 30 weight percent of platinum, are suspended in 63.8 g DMAc using an UltraTurrax (IKA) homogenizer. 2.1 g of a 62 weight percent PTFE suspension (Dyneon TF 5235 PTFE) in DMAc are added to this suspension and suspended, again using the UltraTurrax (IKA). The finished suspension is applied to a 250-μm thick FC X0026 type gas diffusion layer sold by Freudenberg using an airbrush.

The gas diffusion layer coated with the catalyst layer is dried at 120° C. in an N₂ air stream for 30 minutes. The finished gas diffusion electrode has a total thickness of 520 μm and a platinum component of 1.3 mg/cm².

### EXAMPLE 5

### Producing Membrane Electrode Units (MEUs) with the Gas Diffusion Electrodes from Example 3

To produce an MEU, two square pieces measuring 10 cm² are stamped from the gas diffusion electrodes according to Example 3 and impregnated with 13 mg of concentrated phosphoric acid. The two phosphoric acid-impregnated gas diffusion electrodes are applied by their catalyst layer to the center of a square piece measuring 56.25 cm² of a 35-μm thick PBI polymer electrolyte membrane. The membrane electrode sandwich is pressed into an MEU at 160° C. for 2 hours at a pressing force of 3 kN. The MEU thus obtained is ready for installation in fuel cells.

### EXAMPLE 6

### Producing Membrane Electrode Units (MEUs) with the Gas Diffusion Electrodes from Example 4

To produce an MEU, two square pieces measuring 10 cm² are stamped from the gas diffusion electrodes according to Example 4 and impregnated with 17 mg of concentrated phosphoric acid. The phosphoric acid-impregnated gas diffusion electrodes are applied by their catalyst layer to the center of a square piece measuring 56.25 cm² of a 35-μm thick polyelectrolyte membrane of PBI. The membrane electrode sandwich is pressed into an MEU at 160° C. for 2 hours at a pressing force of 3 kN. The MEU thus obtained is ready for installation in fuel cells.

### EXAMPLE 7

### Determining the Performance Parameters of a Fuel Cell Using an MEU Produced According to Example 5

The MEU produced according to example 5 is installed in a test fuel cell sold by Fuel Cell Technology, Inc. and is sealed with a pressure of 15 bar. FIG. 1 shows the current density-voltage curve for the fuel cell at an operating temperature of 160° C. The gas flow was 180 sml/min for H₂ and 580 sml/min for air. Unhumidified gases were used. The performance parameters were determined using an FCATS Advanced Screener sold by Hydrogenics, Inc. The maximum output measured at 4 bar absolute was 0.25 W/cm² at a current density of 0.6 A/cm². The cell impedance was 0.5 Ωcm².

### EXAMPLE 8

### Determining the Performance Parameters of a Fuel Cell Using an MEU Produced According to Example 6

The MEU produced according to Example 6 is installed in a test fuel cell sold by Fuel Cell Technology, Inc. and sealed with a pressure of 15 bar.

FIG. 2 shows the current density-voltage curve for the fuel cell at a working temperature of 160° C. The gas flow was 180 sml/min for H₂ and 580 sml/min for air. Unhumidified gases were used. The performance parameters were determined using an FCATS Advanced Screener sold by Hydrogenics, Inc. The maximum output measured at 4 bar absolute was 0.39 W/cm² at a current density of 0.95 A/cm . The cell impedance was 0.3 Ωcm².

The depicted and specially described embodiments of the invention are of course only examples given by way of illustration. It will be understood by those of ordinary skill in the art that various changes in form and details may be made therein without departing from the spirit and scope of the present invention as defined by the following claims. It is sought, therefore, to cover all such changes and modifications as fall within the spirit and scope of the invention, as defined by the appended claims, and equivalents thereof.

What is claimed is:

1. A gas diffusion electrode, comprising a plurality of gas permeable electrically conductive layers formed of at least one gas diffusion layer and one catalyst layer, wherein the catalyst layer comprises particles of an electrically conductive carrier material, and at least one part of the particles one or both of (i) carries an electrocatalyst and (ii) is at least partially loaded with at least one porous proton-conducting polymer, the proton-conducting polymer being used at temperatures up to or above the boiling point of water.

2. A gas diffusion electrode as claimed in claim 1, wherein the catalyst layer further comprises porous particles of the at least one proton-conducting polymer.

3. A gas diffusion electrode as claimed in claim 1, further comprising an additional gas distributing microstructure layer of electrically conductive particles inserted between the catalyst layer and the gas diffusion layer.

4. A gas diffusion electrode as claimed in claim 3, wherein the electrically conductive particles comprise carbon black.

5. A gas diffusion electrode as claimed in claim 1, wherein the gas diffusion layer comprises carbon.

6. A gas diffusion electrode as claimed in claim 5, wherein the gas diffusion layer is in the form of paper, nonwoven, lattice, knit fabric or woven fabric.

7. A gas diffusion electrode as claimed in claim 1, wherein the electrically conductive carrier material of the catalyst layer is selected from the group consisting of metals, metal oxides, metal carbides, carbons, and mixtures thereof.

8. A gas diffusion electrode as claimed in claim 7, wherein the electrically conductive material of the catalyst layer is carbons, and the carbons comprise carbon black.

9. A gas diffusion electrode as claimed in claim 1, wherein the electrocatalyst is selected from the group consisting of metals and metal alloys.

10. A gas diffusion electrode as claimed in claim 9, wherein the metals are selected from the 8th subgroup of the periodic system of elements.

11. A gas diffusion electrode as claimed in claim 10, wherein the metals are at least one of platinum and ruthenium.

12. A gas diffusion electrode as claimed in claim 1, wherein the at least one porous proton-conducting polymer comprises a nitrogen atom-containing polymer whose nitrogen atom or atoms are chemically bonded to a central atom or atoms of polybasic inorganic oxo acids or their derivatives.

13. A gas diffusion electrode as claimed in claim 1, wherein the at least one porous proton-conducting polymer is selected from the group consisting of polybenzimidazo les, polypyrrid ines, polypyrimidines, polyimidazo les, polybenzothiazoles, polybenzoxazoles, polyoxadiazoles, polyquinoxalines, polythiadiazoles, poly(tetrazapyrenes), polymers carrying reactive groups in a side chain capable of forming amide bonds, polymers having primary or secondary amino groups, and combinations of two or more thereof.

14. A gas diffusion electrode as claimed in claim 12, wherein the central atom or atoms of the oxo acids or their derivatives are selected from the group consisting of phosphorus, sulfur, molybdenum, tungsten, arsenic, antimony, bismuth, selenium, germanium, tin, lead, boron, chromium, silicon, and combinations thereof.

15. A gas diffusion electrode as claimed in claim 14, wherein the derivatives of the oxo acids comprise organic derivatives in the form of alkoxy compounds, esters, amides, or acid chlorides.

16. A gas diffusion electrode as claimed in claim 15, wherein the organic derivatives of the oxo acids comprise 2-(diethylhexyl) phosphate, molybdenyl acetyl acetonate, or tetraethoxysilane.

17. A gas diffusion electrode as claimed in claim 12, wherein the at least one proton-conducting polymer and the oxo acid or derivative are cross-linked into a network.

18. A gas diffusion electrode as claimed in claim 1, wherein the at least one porous proton-conducting polymer is doped with an inorganic acid.

19. A gas diffusion electrode as claimed in claim 18, wherein the dopant is phosphoric acid.

20. A gas diffusion electrode as claimed in claim 12, wherein the at least one proton-conducting polymer has an adjustable affinity for water which can be realized by means of the type and number of introducible hydrophilic and hydrophobic groups on the polymer and/or on the derivatives of the oxo acids.

21. A gas diffusion electrode as claimed in claim 1, wherein the particles of the electrically conductive carrier material are loaded with different porous, proton-conducting polymers.

22. A gas diffusion electrode as claimed in claim 1, wherein part of the particles of the electrically conductive carrier material carries an electrocatalyst, and the part of the particles of the electrically conductive carrier material which carries an electrocatalyst is loaded with a different porous proton-conducting polymer than the part of the particles without electrocatalyst.

23. A gas diffusion electrode as claimed in claim 22, wherein the particles of the electrically conductive carrier material are loaded with at least one porous proton-conducting polymer which is catalytically active itself or which increases the catalytic activity of the electrocatalyst.

24. A gas diffusion electrode as claimed in claim 22, wherein the catalytically active polymer is selected from the group consisting of nitrogen atom-containing polymers whose nitrogen atom or atoms are chemically bonded to a central atom or atoms of polybasic inorganic oxo acids or their derivatives.

25. A gas diffusion electrode as claimed in claim 1, wherein the catalyst layer contains additives.

26. A gas diffusion electrode as claimed in claim 25, wherein the additives comprise a binder or carbon-based spherical particles.

27. A method for producing a gas diffusion electrode comprising a plurality of gas permeable electrically conductive layers which are formed of at least one gas diffusion layer and one catalyst layer, wherein the catalyst layer comprises particles of an electrically conductive carrier material, and at least one part of the particles one or both of (i) carries an electrocatalyst and (ii) is at least partially loaded with at least one porous proton-conducting polymer, the proton-conducting polymer being used at temperatures up to or above the boiling point of water, said method comprising:
A) at least partially loading the surface of the at least one part of the particles of the electrically conductive carrier material with the at least one proton-conducting polymer by suspending the particles in a liquid in which the at least one proton-conducting polymer is dissolved and successively adding the suspension to an agitated non-solvent for the polymer in order to initiate a phase inversion, thereby forming a porous polymer structure on the surface of the particles of the carrier material and porous particles of the at least one proton-conducting polymer;
B) providing at least the electrically conductive particulate carrier material for the catalyst layer in which the at least one part of the particles one or both of (i) carries an electrocatalyst and (ii) is at least partially loaded with at least the porous, proton-conducting polymer obtained in step A);
C) forming the catalyst layer into an electrode form; and
D) contacting the formed catalyst layer with one of the sides of the gas diffusion layer.

28. A method as claimed in claim 27, wherein additives are added to the provided carrier material before step C) is performed.

29. A method as claimed in claim 28, wherein the additives added comprise a binder or spherical carbon based particles.

30. A method as claimed in claim 27, further comprising applying an additional gas distributing microlayer structure of electrically conductive particles to the side of the gas diffusion layer brought into contact with the catalyst layer.

31. A method as claimed in claim 27, wherein, prior to contacting the catalyst layer with the one side of the gas diffusion layer, the formed catalyst layer is first applied to at least one of the sides of a polymer electrolyte membrane.

32. A method as claimed in claim 27, wherein the electrically conductive particulate carrier material for the catalyst layer is provided in the form of a powder, and the catalyst layer is formed into the electrode form by rolling the powder.

33. A method as claimed in claim 27, wherein the electrically conductive particulate carrier material for the catalyst layer is provided in the form of a suspension or paste, and the catalyst layer is formed into the electrode form by applying the suspension or paste to at least one substrate and subsequently drying it.

34. A method as claimed in claim 33, wherein the gas diffusion layer or a polymer electrolyte membrane is used as the substrate.

35. A method as claimed in claim 27, wherein the proton-conducting polymer comprises a nitrogen atom-containing polymer whose nitrogen atom or atoms are chemically bonded to a central atom or atoms of polybasic inorganic oxo acids or their derivatives.

36. A method as claimed in claim 27, wherein the proton-conducting polymer is selected from the group consisting of polybenzimidazoles, polypyrridines, polypyrimidines, polyimidazoles, polybenzothiazoles, polybenzoxazoles, polyoxadiazoles, polyquinoxalines, polythiadiazoles, poly(tetrazapyrenes), polymers carrying reactive groups in a side chain capable of forming amide bonds, polymers having primary or secondary amino groups, and combinations of two or more thereof.

37. A method as claimed in claim 35, wherein the oxo acids or their derivatives comprise a central atom selected from the group consisting of phosphorus, sulfur, molybdenum, tungsten, arsenic, antimony, bismuth, selenium, germanium, tin, lead, boron, chromium, and silicon.

38. A method as claimed in claim 35, wherein the derivatives of oxo acids comprise organic derivatives in the form of alkoxy compounds, esters, amides, or acid chlorides.

39. A method as claimed in claim 38, wherein the organic derivatives of the oxo acids comprise 2-(diethylhexyl) phosphate, molybdenyl acetyl acetonate, or tetraethoxysilane.

40. A method as claimed in claim 35, wherein the at least one proton-conducting polymer and the oxo acid or derivative are cross-linked into a network through the effect of heat.

41. A method as claimed in claim 35, wherein the affinity for water of the at least one proton-conducting polymer is adjusted by means of the type and number of hydrophilic and hydrophobic groups on the polymers and/or on the derivatives of the oxo acids.

42. A fuel cell for operation at temperatures of up to at least 200° C., comprising at least one membrane electrode unit comprising two gas diffusion electrodes and a polymer electrolyte membrane sandwiched between the two gas diffusion electrodes, wherein each gas diffusion electrode comprises a plurality of gas permeable electrically conductive layers comprising at least one gas diffusion layer and one catalyst layer, wherein the catalyst layer comprises particles of an electrically conductive carrier material, and at least one part of the particles one or both of (i) carries an electrocatalyst and (ii) is at least partially loaded with at least one porous proton-conducting polymer, the proton-conducting polymer being used at temperatures up to or above the boiling point of water.

43. A fuel cell as claimed in claim 42, wherein the gas diffusion electrodes and the polymer electrolyte membranes of the membrane electrode units comprise the same at least one proton-conducting polymer.
